(19) United States
(12) Patent Application Publication
(10) Pub. No.: US 2024/0379310 A1
(43) Pub. Date: Nov. 14, 2024

(54) SOLID-STATE SURGE-RESISTANT INTERRUPTION RELAY FOR A PIPELINE CATHODIC PROTECTION SYSTEM

(71) Applicant: American Innovations, Ltd., Austin, TX (US)

(72) Inventors: Chris Jones, Kingsbury, TX (US); Zee McClane, Austin, TX (US); Dan Huslig, Austin, TX (US); Dale Webb, Austin, TX (US); Garrett Jones, Round Rock, TX (US)

(73) Assignee: American Innovations, Ltd., Austin, TX (US)

(21) Appl. No.: 18/661,123

(22) Filed: May 10, 2024

Related U.S. Application Data
(60) Provisional application No. 63/501,216, filed on May 10, 2023.

(51) Int. Cl. H01H 50/02; C23F 13/06

(52) U.S. Cl. CPC H01H 50/021; C23F 13/06; H01H 50/02

(57) ABSTRACT

A disclosed CPS relay assembly includes a polymeric housing, a relay switch printed circuit board (PCB) assembly (PCA) within the housing, a thermal substrate or heatsink, and a film of isolation material between the thermal substrate and the relay switch PCA. The isolation material may be a thermally conductive and electrically isolating potting compound. The relay assembly may further include a relay control PCA within the housing. The housing itself may comprise an injection molded plastic, e.g., thermoset or thermoplastic. The housing may include one or more standoff features configured to define a gap of a predetermined dimension between the thermal substrate and the relay switch PCA. The isolation material may exhibit a thermal conductivity of 0.1-3 W/m-K and one or more desirable characteristics for maintaining electrical isolation of the relay assembly. Such electrical characteristics may include as examples, a minimum 60 Hz impedance of 1×10¹⁵ ohm-cm and a dielectric constant (Dk) of approximately 3-10.

### TECHNICAL FIELD

The present disclosure pertains to cathodic protection systems and, more specifically, relays for interrupting current from a cathodic protection system rectifier.

### BACKGROUND

Underground pipelines comprised of steel, carbon steel, and other metallic compositions are widely used to transport oil, natural gas, and other chemically stable fluids. An underground pipeline may be provisioned with a cathodic protection system (CPS) designed to mitigate pipeline corrosion risk that is present whenever a metallic structure is placed in contact with an electrolytic medium such as soil.

An impressed current CPS includes a rectifier coupled to the underground pipeline and configured to drive rectifier current into a metallic anode structure buried near the pipeline. The rectifier current changes the voltage across the metal/soil interface, thereby changing the electrochemical state of the structure to reduce or prevent corrosion. The voltage across the metal/soil interface, generally referred to as the “pipe-to-soil” potential, is monitored to confirm that corrosion protection measures are functioning as intended.

Various criteria are commonly used within the industry to assess the adequacy of the pipe-to-soil potential. One generally accepted criterion requires a pipe-to-soil potential more negative than-0.85 V when the cathodic protection circuits are switched on, i.e., when the rectifier is delivering cathodic protection current into the CPS circuit. However, measuring pipe-to-soil potential is non-trivial at least in part because the cathodic protection current produces an ohmic voltage drop in the pipe-to-soil measurement circuit. To resolve this is, pipe-to-soil potential is often measured by first interrupting the cathodic protection current and, very quickly thereafter, measuring the pipe-to-soil voltage.

As a result, it is standard practice to provision a CPS with an interrupt relay. Typically, the interrupt relay is affixed to the rectifier chassis, which is tied to earth ground. During severe environmental conditions including lighting storms, it is possible for the relay and, more specifically, an electrically conductive heat sink of the interrupt, to enable a transient and unintended electrical path between a secondary winding of a rectifier transformer and ground via the rectifier chassis. Accordingly, it is desirable to electrically isolate the interrupt relay heatsink. Typically, however, improved isolation is achieved at the cost of a decrease in heatsink effectiveness.

### SUMMARY

In accordance with teachings disclosed herein, common problems associated with the issues referenced above are addressed by a disclosed CPS relay assembly, which may include a polymeric housing, a relay switch printed circuit board (PCB) assembly (PCA) within the housing, a thermal substrate, also referred to herein simply as a heatsink, and a film of isolation material between the thermal substrate and the relay switch PCA. The isolation material may be a thermally conductive and electrically isolating potting compound, between the thermal substrate and the relay switch PCA. The relay assembly may further include a relay control PCA within the housing.

The housing itself may comprise an injection molded plastic, e.g., thermoset or thermoplastic. The housing may include one or more standoff features configured to define a gap of a predetermined dimension between the thermal substrate and the relay switch PCA. The dimension of the gap may be determined in accordance with a desired thickness of the isolation material film between the heatsink and the relay switch PCA. A desired thickness for the isolation material film may be approximately 0.050 inches. In at least one such embodiment, the isolation material may exhibit a thermal conductivity of 0.1-3 W/m-K. The isolation material may also exhibit desirable characteristics for maintaining electrical isolation of the relay assembly. Such electrical characteristics may include as examples, a minimum 60 Hz impedance of 1×10¹⁵ ohm-cm and a dielectric constant (Dk) of approximately 3-10.

In at least some embodiments, the relay assembly may include one or more flying leads for connecting an external signal, such as the signal from a secondary winding of transformer in a CPS rectifier. Embodiments may employ a metal-clad relay control PCA for improved thermal dissipation. One or more magnets may be incorporated in the assembly for affixing the assembly to a metallic structure such as the chassis of the CPS rectifier.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an exemplary cathodic protection system;

FIG. 2 illustrate a sectional elevation view of a relay assembly for use in the system of FIG. 1;

FIGS. 3 and 4 illustrate font and back perspective a housing of the relay assembly;

FIG. 5 illustrates detail of a section of FIG. 4; and

FIG. 6 illustrates an exploded view of the relay assembly.

### DETAILED DESCRIPTION

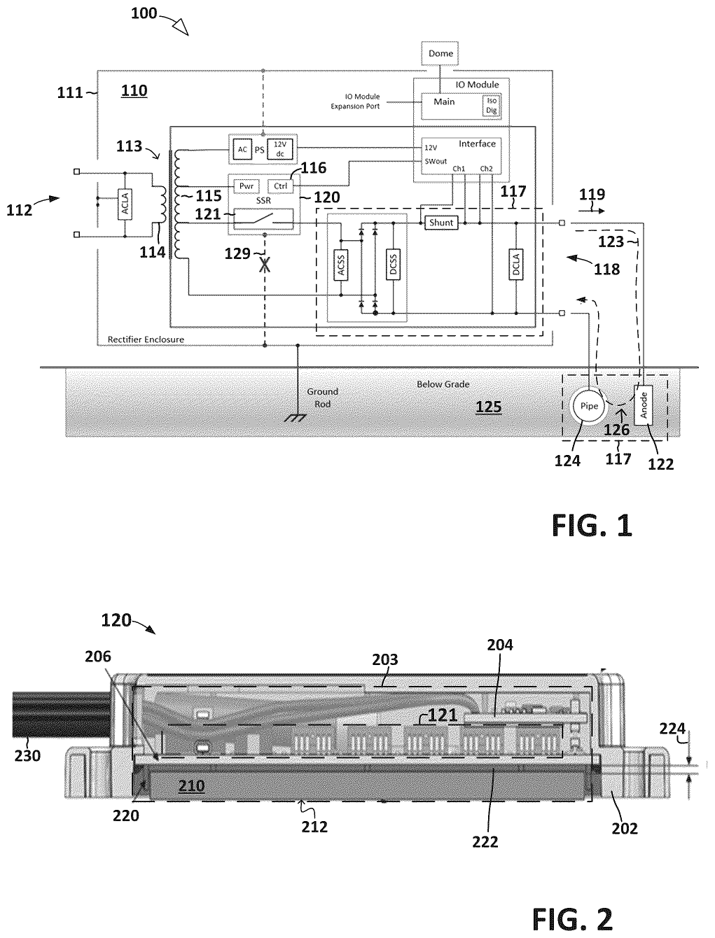

Exemplary embodiments and their advantages are best understood by reference to FIGS. 1-6, wherein like numbers are used to indicate like and corresponding parts unless expressly indicated otherwise.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically. Thus, for example, “device 12-1” refers to an instance of a device class, which may be referred to collectively as “devices 12” and any one of which may be referred to generically as “a device 12”.

As used herein, when two or more elements are referred to as “coupled” to one another, such term indicates that such two or more elements are in electronic communication, mechanical communication, including thermal and fluidic communication, thermal, communication or mechanical communication, as applicable, whether connected indirectly or directly, with or without intervening elements.

Referring now to the drawings, FIG. 1 depicts a surge-resistant cathodic protection system 100, referred to herein more simply as CPS 100, including a surge-resistant rectifier 110, referred to herein simply as rectifier 110, featuring a surge-resistant interrupt relay assembly 120, referred to herein simply as relay assembly 120, including a solid state relay 121. The illustrated rectifier 110 includes an earth-grounded chassis enclosure 111, an input port 112, for receiving an alternating current (AC) input, and a transformer 113 with a primary winding 114 coupled to input port 112. A secondary winding 115 of transformer 113 is coupled to relay assembly 120. When a control node 116 of relay assembly 120 is activated, SSR 121 closes to couple the AC signal of secondary winding 115 to rectifying circuitry 117. When an output port 118 of rectifier 110 is coupled to an underground rectifier load, rectifying circuitry 117 drives a DC rectifier current 119 via an underground current path 123 that includes an anodic structure or, more simply, anode 122, underground pipeline 124, and a portion 126 of soil (125) between anode 120 and pipeline 124.

Relay assembly 120 may be affixed to the earth-grounded chassis enclosure 111 of rectifier 110 and those of ordinary skill in the field of cathode protection will recognize that relay assemblies, such as the illustrated relay assembly 120, may be subjected to significant stresses when deployed in cathodic protection environments. As an example, lightening can produce an induced lightening surge voltage exceeding 10 kV with a duration in the range of 100 to 1000 microseconds and direct lightening surges may be an order of magnitude more severe. During any such significant power surge, an unintended and transient current path, referred to herein as a surge path 129, may be created from secondary winding 115 to the grounded rectifier chassis 111 via SSR 121.

Surge path 129 forms, at least in part, because SSR 121 is generally provisioned with a substantial heat sink (not depicted explicitly in FIG. 1) that is in good thermal contact with SSR 121 and with a thermal “ground” structure such as rectifier chassis 111. Materials suitable for use as a heat sink in this context, however, tend also to exhibit high electrical conductivity. Locating a grounded, electrically conductive structure in close physical proximity to a component designed to accommodate a high voltage AC signal is inherently risky. Conventional CPS designs are confronted with competing needs to achieve adequate thermal coupling for a CPS interrupt relay while maintaining sufficient electrical isolation to withstand potentially significant surges and spikes in power, signal, and the like.

Turning now to FIG. 2, a sectional elevation view of an exemplary implementation of relay assembly 120 is depicted. The depicted relay assembly 120 includes a housing 202 defining an enclosure space 203 in which a pair of printed circuit board (PCB) assemblies (PCAs), including a control PCA 204 and a switch PCA 206, and a heat sink 210 are located. The illustrated relay assembly 120 further includes a thermally conductive and electrically insulating material, referred to herein as isolation material 220. As depicted in FIG. 2, isolation material 220 surrounds heat sink 210 on all sides other than an exterior-facing side 212 of heat sink 210. The isolation material 220 includes a film 222 of substantially uniform thickness between heat sink 210 and switch PCA 206.

A thickness 224 of film 222 influences at least two potentially competing performance characteristics of relay assembly 120. Thickness 224 must be sufficient, in conjunction with other physical, mechanical, and electrical characteristics of isolation material 220 and other components of relay assembly 120, to ensure adequate electro-magnetic isolation between heat sink 210 and the SSR 121 of relay assembly 120. In at least some embodiments, adequate isolation may require isolation capable of withstanding a transient electrical surge or voltage spike of 30 kV or more including, without limitation, an electrical surge associated with a direct or indirect lighting event. In addition, isolation material 220 must exhibit sufficient thermal conductivity to maintain adequate thermal control of SSR 121. Generally, increasing the thickness 224 of isolation material film 222 improves electrical isolation but decreases thermal conductivity. In at least one embodiment, adequate isolation and thermal conductivity are achieved simultaneously using a thickness 224 of approximately 0.050 inches and an isolation material 220 with a thermal conductivity of 0.1-3 W/m-K and electrical properties including a minimum 60 Hz impedance of 1×10¹⁵ ohm-cm and a relative permittivity or dielectric constant (Dk) of 3-10.

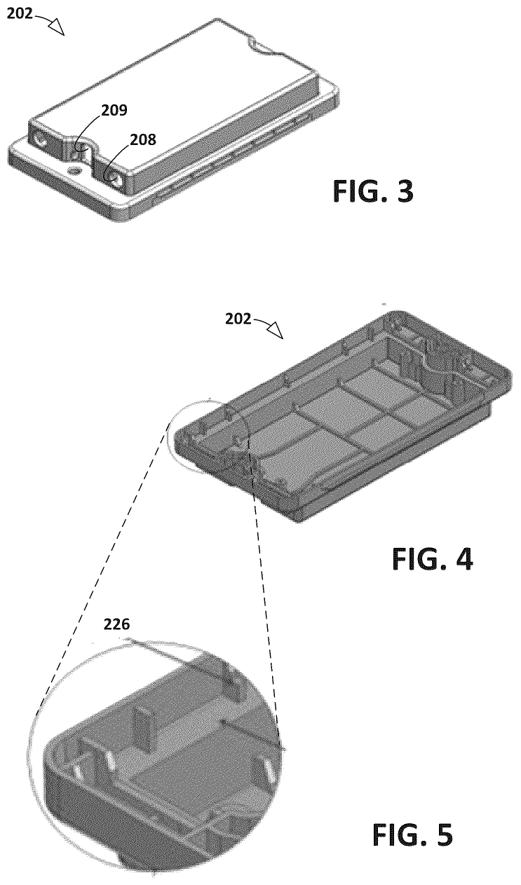

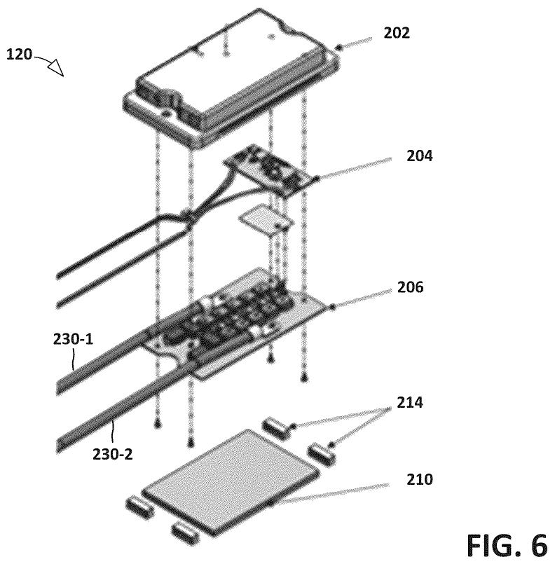

Referring now to FIGS. 3, 4, and 5, an exemplary housing 202 is depicted in isolated perspective views. Housing 202 may be fabricated as an injection-molded thermoplastic or thermoset polymer. Housing 202 serves as the primary mechanical framework for relay assembly 120 (depicted in FIGS. 1 and 2). In addition to providing a protective cover for the electronics, housing 202 functions as a potting box for a thermally conductive potting compound that serves as isolation material 220. In at least some such embodiments, isolation material 220 is applied after PCAs 204 and 206 (FIG. 2) have been installed. The housing 202 illustrated in FIG. 3 includes one or more openings 208 to accommodate one or more flying leads (see FIG. 6 and the accompanying description) as well as one or more openings 209 enabling post-assembly delivery of a potting material for use as isolation material 220, i.e., after PCAs 204 and 206 have been affixed or installed within the housing enclosure 203 (FIG. 1).

As depicted in the detail view of FIG. 5, housing 202 may include mechanical ribs 226 to establish and enforce a desired displacement or gap between switch PCA 206 (FIG. 2) and heatsink 210 (FIG. 2). The gap will be filled with the thermally conductive potting material to achieve the necessary electrical isolation as well as maintain a good thermal path to heat sink 210.

FIG. 6 illustrates an exploded view of an exemplary relay assembly 120. The relay assembly depicted in FIG. 6 includes housing 202, control PCA 204, switch PCA 206, and heatsink 210. As depicted in FIG. 6, relay assembly 120 may include one or more flying leads 230, two of which are depicted in FIG. 6 (230-1, 230-2). The illustrated flying leads 230 are electrical wires or cable that provide an electrical interconnect between one or more nodes of switch PCA 206 and one or more external components or nodes (not depicted in FIG. 6). In at least some embodiments, flying leads 206 carry the relay assembly output signal provided to the rectifying circuit 118 (FIG. 1). The use of flying leads 230 to convey the relay output may beneficially improve electrical isolation properties of relay assembly 120.

The electrically isolated thermal heatsink 210 and the incorporation of flying leads 230 into the design of relay assembly 120 enable, at least in part, relay assembly 120 to achieve high surge immunity level and excellent thermal dissipation performance. In addition, the use of flying leads 230 provide the end-user with desirable flexibility to mount the assembly without concern for inadvertent arc paths to the rectifier enclosure/frame from exposed cable terminals. A desirable feature of relay assembly 120 is improved electrical isolation between the heatsink interface and electrically active elements of the SSR 121. In at least some embodiments, isolation material 220, which has desirable electrical breakdown characteristics and thermal conductivity, is introduced to improve the electrical isolation of the heatsink interface. In at least some embodiments, switch PCA 206 is implemented as a metal-clad PCA to aid as a thermal spreader to improve thermal transfer to the heatsink interface. The gap between the metal-clad circuit and the heatsink interface is controlled and filled with isolation material. Isolation material provides mechanical attachment between metal-clad circuits, heatsink interfaces, and enclosures.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A relay assembly, comprising:
a polymeric housing;
a relay switch printed circuit board (PCB) assembly (PCA) within the housing;
a thermal substrate; and
a film of isolation material, comprising a thermally conductive and electrically isolating potting compound, between the thermal substrate and the relay switch PCA.

2. The relay assembly of claim 1, further comprising a relay control PCA within the housing.

3. The relay assembly of claim 1, wherein the polymeric housing comprises injection molded polymer selected from: an injection molded thermoplastic polymer and an injection molded thermoset polymer.

4. The relay assembly of claim 1, further comprising one or more flying lead connections to the relay switch PCA.

5. The relay assembly of claim 1, wherein the relay control PCA comprises a metal clad PCA.

6. The relay assembly of claim 1, further comprising one or more magnets for maintained the relay assembly in contact with a metallic chassis of a cathodic protection system rectifier.

7. The relay assembly of claim 1, wherein the polymeric housing includes one or more standoff features configured to define a gap of a predetermined dimensions between the thermal substrate and the relay switch PCA.

8. The relay assembly of claim 7, wherein the gap determines a thickness of the isolation material.

9. The relay assembly of claim 1, wherein the isolation material has a thickness of approximately 0.050 inches.

10. The relay assembly of claim 9, wherein the isolation material has a thermal conductivity of 0.1-3 W/m-K.
